(19) United States
(12) Patent Application Publication
(10) Pub. No.: US 2020/0000043 A1
(43) Pub. Date: Jan. 2, 2020

(54) UNDER CANOPY ELECTROMAGNETIC RADIATION DEVICE

(71) Applicant: THRIVE AGRITECH, New York, NY (US)

(72) Inventors: Brian BENNETT, New York, NY (US); Chuck DeMILO, Marblehead, MA (US); Joel CHENEY, Denver, CO (US)

(73) Assignee: THRIVE AGRITECH, New York, NY (US)

(21) Appl. No.: 16/298,449

(22) Filed: Mar. 11, 2019

Related U.S. Application Data
(60) Provisional application No. 62/692,216, filed on Jun. 29, 2018.

(51) Int. Cl. A01G 7/04; A01G 13/02

(52) U.S. Cl. CPC A01G 7/045; A01G 13/0206

(57) ABSTRACT

Technologies are described for systems and devices to provide photosynthetically active photons to a plant. The systems may comprise an above canopy light source. The above canopy light source may be an electromagnetic radiation device. The above canopy light source may be located above a canopy of the plant. The above canopy light source may emit photosynthetically active photons of a first intensity downward, towards a canopy of the plant. The systems may comprise an under canopy light source. The under canopy light source may be an electromagnetic radiation device. The under canopy light source may be located below the lowest branches and leaves of the plant. The under canopy light source may emit photosynthetically active photons of a second intensity upwards, away from a root system of the plant. The second intensity may be 0-50 percent of the first intensity.

### CROSS REFERENCE TO RELATED APPLICATIONS

This application claims priority to Provisional Application No. 62/692,216 filed Jun. 28, 2018, the entirety of which is hereby incorporated by reference.

### BACKGROUND

This application relates to an electromagnetic radiation device that can be used to increase horticulture production when located below the plant canopy. This application relates to Controlled Environment Agriculture (CEA). In Controlled Environment Agriculture farming, plants are grown indoors or inside structures like greenhouses. In Controlled Environment Agriculture farming, the environment may be controlled using artificial lighting.

Light may be comprised of electromagnetic waves. Electromagnetic waves may have electric amplitudes which vary at a specific frequency or wavelength. Light which includes electromagnetic wavelengths between 400 nm and 700 nm may be generally considered photosynthetically active radiation (PAR). Within the photosynthetically active radiation range of electromagnetic wavelengths between 400 nm and 700 nm, each type of plant may have a unique response to specific wavelengths and different mixtures of wavelengths. Photons of light with different wavelengths may yield different amounts of growth of a type of plant. A photosynthetic response curve may exist for each type of plant. A total photosynthetic rate may be determined based on the quantity and wavelength of photons encountered by a plant.

Within controlled environment agriculture, lighting such as grow lights, may be used in a configuration known as top lighting. Top lighting may provide illumination for photosynthesis to plants from above a canopy of the plants. In some instances, lighting below the top of the canopy, called inter-lighting or side lighting, may be utilized. Inter-lighting may include a photosynthetically active radiation device with an optical axis directed in a substantially perpendicular direction to the primary growth axis of the plant, i.e. in a parallel direction relative to the ground or soil plants are rooted within. Inter-lighting with a photosynthetically active radiation device with an optical axis directed in a parallel direction relative to the ground plants are rooted within, may be utilized for tomatoes and other plants. Inter-lighting devices may be positioned above the lowest branches and/or leaves of a target plant and a substantial portion of the photosynthetically active radiation emitted by the inter-lighting device may be in a downward direction (toward a root system of the plant). Inter-lighting devices may be targeted at a single plant, or a single line of plants.

### SUMMARY

In some examples system to provide photosynthetically active photons to a plant are described. The systems may comprise an above canopy light source. The above canopy light source may be an electromagnetic radiation device. The above canopy light source may be located above a canopy of the plant. The above canopy light source may emit photosynthetically active photons of a first intensity downward, towards a canopy of the plant. The systems may comprise an under canopy light source. The under canopy light source may be an electromagnetic radiation device. The under canopy light source may be located below the lowest branches and leaves of the plant. The under canopy light source may emit photosynthetically active photons of a second intensity upwards, away from a root system of the plant. The second intensity may be 0-50 percent of the first intensity.

In some examples, devices to provide photosynthetically active photons to a plant are described. The devices may comprise an under canopy light source. The under canopy light source may be an electromagnetic radiation device. The under canopy light source may be located below the lowest branches and leaves of the plant. The under canopy light source may emit photosynthetically active photons of a first intensity upwards away from a root system of the plant. The first intensity may be 0-50 percent of a second intensity. The second intensity may be an intensity of an above canopy light source. The above canopy light source may be an electromagnetic radiation device. The above canopy light source may be located above a canopy of the plant. The above canopy light source may emit photosynthetically active photons of the second intensity downward, towards the plant canopy.

In some examples, systems to provide photosynthetically active photons to plants planted in an area are described. The systems may comprise a plurality of above canopy light sources. The above canopy light sources may be electromagnetic radiation devices. The above canopy light sources may be located above a canopy of the plants. The above canopy light sources may emit photosynthetically active photons of a first intensity downward, towards a canopy of the plants. The systems may comprise a plurality of under canopy light sources. The under canopy light sources may be electromagnetic radiation devices. The under canopy light sources may be located below the lowest branches and leaves of the plants. The under canopy light sources may emit photosynthetically active photons of a second intensity upwards away from a root system of the plants. The second intensity may be 0-50 percent of the first intensity.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system utilizing an under canopy electromagnetic radiation device;

FIG. 2 illustrates an example system utilizing a plurality of under canopy electromagnetic radiation devices;

all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

It will be understood that any compound, material or substance which is expressly or implicitly disclosed in the specification and/or recited in a claim as belonging to a group or structurally, compositionally and/or functionally related compounds, materials or substances, includes individual representatives of the group and all combinations thereof.

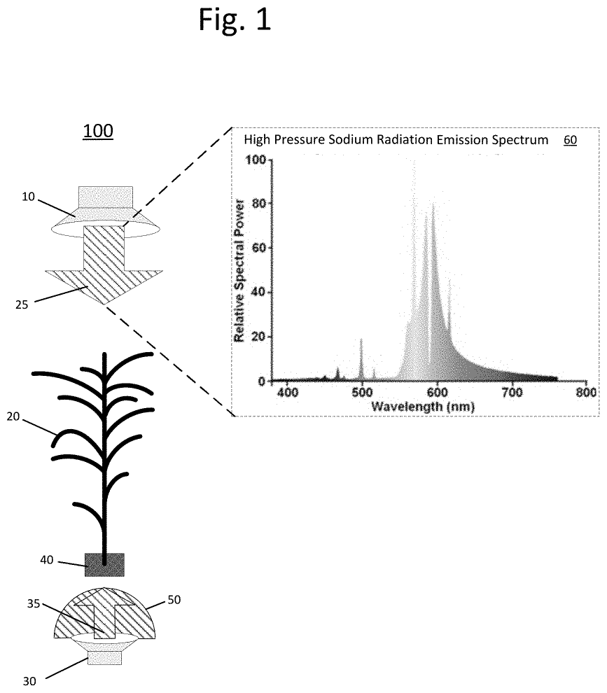

FIG. 1 illustrates an example system utilizing an under canopy electromagnetic radiation device, arranged in accordance with at least some embodiments presented herein. As discussed in more detail below, an under canopy electromagnetic radiation device may generated electromagnetic waves below the lowest branches and leaves of a plant, and may increase a biomass and yield of the plant.

System 100 may include an above canopy light source 10, a crop or plant 20, and an under canopy light source 30. Above canopy light source 10 may be located above a canopy of plant 20. Above canopy light source 10 may emit above canopy electromagnetic radiation 25 with an optical axis in a downward direction towards plant 20. Above canopy light source 10 may emit wavelengths of light between 400 nm and 700 nm. Above canopy electromagnetic radiation 25 emitted by above canopy light source 10 may be photosynthetically active radiation (PAR). Above canopy light source 10 may be a high pressure sodium (HPS) lighting device, a light emitting diode (LED) lighting device, a fluorescent lighting device, a grow lighting device designed for indoor farming, or any other type of lighting device.

Under canopy light source 30 may be located below the lowest branches and leaves of plant 20. Under canopy light source 30 may emit under canopy electromagnetic radiation 35. Under canopy light source 30 may emit wavelengths of light between 400 nm and 700 nm. Under canopy electromagnetic radiation 35 emitted by under canopy light source 30 may be photosynthetically active radiation (PAR). Under canopy electromagnetic radiation 35 emitted by under canopy light source 30 may have an optical axis in an upward direction away from a root system of plant 20, i.e., in an upward perpendicular direction relative to ground/soil 40 that plant 20 is rooted within and parallel to a primary growth axis of plant 20.

Under canopy electromagnetic radiation 35 emitted by under canopy light source 30 may be a Lambertian emission of photosynthetically active radiation. Under canopy electromagnetic radiation 35 emitted by light source 30 may be a wide angular emission which may cause emitted photons from under canopy light source 30 to reach a targeted plant 20 within a 180° hemispherical field-of-view 50 of under canopy light source 30.

Above canopy light source 10 and under canopy light source 30 may emit the same or different wavelengths of photosynthetically active radiation (PAR) in above canopy electromagnetic radiation 25 and under canopy electromagnetic radiation 35 respectively. Different wavelengths of photosynthetically active radiation (PAR) in above canopy electromagnetic radiation 25 may have different efficacies in penetrating through a canopy of plant 20 to the lower regions of plant 20. For example, when above canopy electromagnetic radiation 25 includes electromagnetic radiation for green light in the waveband between 520 nm-550 nm, above canopy electromagnetic radiation 25 may exhibit efficacious penetration through a canopy of plant 20 to lower regions of plant 20. In another example, when above canopy electromagnetic radiation 25 includes electromagnetic radiation for yellow light in the waveband between 570 nm-590 nm, above canopy electromagnetic radiation 25 may not exhibit efficacious penetration through a canopy of plant 20 to lower regions of plant 20.

Above canopy light source 10 may include lighting technology used in indoor farming such as high pressure sodium (HPS) devices. Above canopy light source 10 may include high pressure sodium (HPS) devices and above canopy electromagnetic radiation 25 may emit electromagnetic radiation 25 with an emission spectrum 60.

Emission spectrum 60 may show a relatively small quantity of green light within a relative spectral power distribution of emission spectrum 60 for high pressure sodium (HPS) lighting. A small quantity of green light in relative spectral power distribution of high pressure sodium (HPS) lighting may hinder penetration of photosynthetically active radiation in above canopy electromagnetic radiation 25 through a canopy of plant 20.

Under canopy light source 30 may provide under canopy electromagnetic radiation 35 in conjunction with above canopy electromagnetic radiation 25 provided by above canopy light source 10. When above canopy electromagnetic radiation 25 provided by above canopy light source 10 includes a small quantity of green light in relative spectral power distribution of emission spectrum 60, under canopy electromagnetic radiation 35 may improve plant 20 biomass and yield by increasing the amount of photosynthetically active radiation (PAR) and photosynthesis at the lower regions of plant 20 within an indoor farming environment.

A correlation may be determined between photosynthetically active radiation (PAR) intensity of the combination of above canopy electromagnetic radiation 25 and under canopy electromagnetic radiation 35 with a photosynthesis efficacy of plant 20. Photosynthetically active radiation (PAR) intensity may be a measure of wavelength-weighted power emitted in a particular direction by above canopy light source 10 or under canopy light source 30, and may be measured in candela (cd). A combination of above canopy electromagnetic radiation 25 and under canopy electromagnetic radiation 35 may optimize photosynthesis of plant 20.

Above canopy electromagnetic radiation 25 and under canopy electromagnetic radiation 35 may optimize photosynthesis of plant 20 when an intensity of under canopy electromagnetic radiation 35 is a percentage of an intensity of above canopy electromagnetic radiation 25. Above canopy electromagnetic radiation 25 and under canopy electromagnetic radiation 35 may optimize photosynthesis of plant 20 when an intensity of under canopy electromagnetic radiation 35 is 0-50 percentage of an intensity of above canopy electromagnetic radiation 25. In a preferred embodiment, above canopy electromagnetic radiation 25 and under canopy electromagnetic radiation 35 may optimize photosynthesis of plant 20 when an intensity of under canopy electromagnetic radiation 35 is 10-15 percentage of an intensity of above canopy electromagnetic radiation 25. When an intensity of under canopy electromagnetic radiation 35 is substantially less than 10-15% of an intensity of above canopy electromagnetic radiation 25, plant 20 may not produce sufficient photosynthesis. When an intensity of under canopy electromagnetic radiation 35 is substantially more than 10-15% of an intensity of above canopy electromagnetic radiation 25, plant 20 may only receive minor incremental photosynthesis benefit.

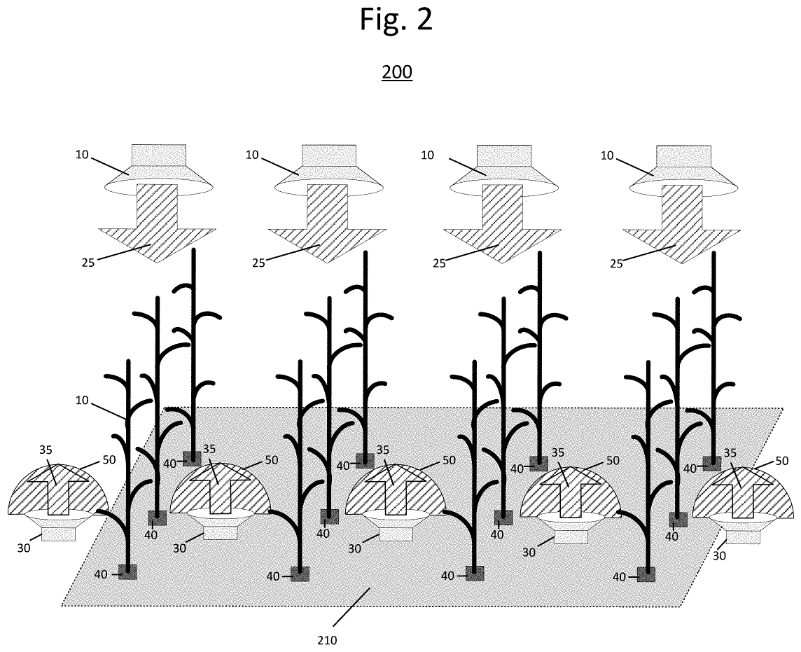

FIG. 2 illustrates an example system utilizing a plurality of under canopy electromagnetic radiation devices, arranged in accordance with at least some embodiments presented herein. Those components in FIG. 2 that are labeled identically to components of FIG. 1 will not be described again for the purposes of clarity.

System 200 may include a plurality of above canopy light sources 10, crop or plants 20, and a plurality of under canopy light sources 30. Above canopy light sources 10 may be located above the canopy of plants 20 and may emit above canopy electromagnetic radiation 25 with an optical axis in a downward direction towards plants 20. Above canopy light sources may be arranged to provide above canopy electromagnetic radiation 25 over an area 210 where plants 20 are planted. Above canopy light sources 10 may emit wavelengths of light between 400 nm and 700 nm. In an example, above canopy light sources 10 may each emit the same wavelength of light. In another example, above canopy light sources 10 may each emit a different wavelength of light. In another example, some above canopy light sources 10 may each emit the same wavelength of light and some above canopy light sources 10 may emit a different wavelength of light. In another example, above canopy light sources 10 may emit any combination of wavelengths of light between 400 nm and 700 nm respectively. Above canopy electromagnetic radiation 25 emitted by above canopy light sources 10 may be photosynthetically active radiation (PAR). Above canopy light sources 10 may be high pressure sodium (HPS) lighting devices, light emitting diode (LED) lighting devices, fluorescent lighting devices, grow lighting devices designed for indoor farming, or any other type of lighting devices.

Under canopy light sources 30 may be located below the lowest branches and leaves of plants 20. Under canopy light sources 30 may emit under canopy electromagnetic radiation 35. Under canopy light sources 30 may emit wavelengths of light between 400 nm and 700 nm. Under canopy electromagnetic radiation 35 emitted by under canopy light sources 30 may be photosynthetically active radiation (PAR). Under canopy electromagnetic radiation 35 emitted by under canopy light sources 30 may have an optical axis in an upward direction away from a root system of plants 20, i.e., in an upward perpendicular direction relative to ground/soil 40 that plants 20 are rooted within and parallel to a primary growth axis of plants 20.

Under canopy electromagnetic radiation 35 emitted by under canopy light sources 30 may be a Lambertian emission of photosynthetically active radiation. Under canopy electromagnetic radiation 35 emitted by each light source 30 may be a wide angular emission which may cause emitted photons from each under canopy light source 30 to reach targeted plants 20 within a 180° (hemispherical) field-of-view 50 of each under canopy light source 30 respectively.

Above canopy light sources 10 and under canopy light sources 30 may emit the same or different wavelengths of photosynthetically active radiation (PAR) in above canopy electromagnetic radiation 25 and under canopy electromagnetic radiation 35 respectively. Different wavelengths of photosynthetically active radiation (PAR) in above canopy electromagnetic radiation 25 may have different efficacies in penetrating through a canopy of plants 20 to the lower regions of plants 20. For example, when above canopy electromagnetic radiation 25 includes electromagnetic radiation for green light in the waveband between 520 nm-550 nm, above canopy electromagnetic radiation 25 may exhibit efficacious penetration through a canopy of plants 20 to lower regions of plants 20. In another example, when above canopy electromagnetic radiation 25 includes electromagnetic radiation for yellow light in the waveband between 570 nm-590 nm, above canopy electromagnetic radiation 25 may not exhibit efficacious penetration through a canopy of plants 20 to lower regions of plants 20.

Under canopy light sources 30 may provide under canopy electromagnetic radiation 35 in conjunction with above canopy electromagnetic radiation 25 provided by above canopy light sources 10. When above canopy electromagnetic radiation 25 provided by above canopy light sources 10 includes a small quantity of green light in relative spectral power distribution 60, under canopy electromagnetic radiation 35 may improve plants 20 biomass and yield by increasing the amount of photosynthetically active radiation (PAR) and photosynthesis at the lower regions of plants 20 within an indoor farming environment.

A correlation may be determined between photosynthetically active radiation (PAR) intensity of the combination of above canopy electromagnetic radiation 25 and under canopy electromagnetic radiation 35 with a photosynthesis efficacy of plants 20. Photosynthetically active radiation (PAR) intensity may be a measure of wavelength-weighted power emitted in a particular direction by above canopy light sources 10 or under canopy light sources 30, and may be measured in candela (cd). A combination of above canopy electromagnetic radiation 25 and under canopy electromagnetic radiation 35 may optimize photosynthesis of plants 20.

Above canopy electromagnetic radiation 25 and under canopy electromagnetic radiation 35 may optimize photosynthesis of plants 20 when an intensity of under canopy electromagnetic radiation 35 is a percentage of an intensity of above canopy electromagnetic radiation 25. Above canopy electromagnetic radiation 25 and under canopy electromagnetic radiation 35 may optimize photosynthesis of plant 20 when an intensity of under canopy electromagnetic radiation 35 is 0-50 percentage of an intensity of above canopy electromagnetic radiation 25. In a preferred embodiment, above canopy electromagnetic radiation 25 and under canopy electromagnetic radiation 35 may optimize photosynthesis of plants 20 when an intensity of under canopy electromagnetic radiation 35 is 10-15 percentage of an intensity of above canopy electromagnetic radiation 25. When an intensity of under canopy electromagnetic radiation 35 is substantially less than 10-15% of an intensity of above canopy electromagnetic radiation 25, plants 20 may not produce sufficient photosynthesis. When an intensity of under canopy electromagnetic radiation 35 is substantially more than 10-15% of an intensity of above canopy electromagnetic radiation 25, plants 20 may only receive minor incremental photosynthesis benefit.

A system in accordance with the present disclosure may promote photosynthesis within both the canopy and the under canopy of a plant when using artificial lighting. A system in accordance with the present disclosure may promote photosynthesis when a crop is relatively tall with a high-density canopy, and may overcome shadowing that may prevent photosynthetically active radiation from overhead lighting from reaching lower regions of the plant. A system in accordance with the present disclosure may prevent a deficiency of photosynthetically active radiation at lower levels of a crop canopy that may result in substantially less photosynthesis and crop production. A system in accordance with the present disclosure may improve plant biomass and yield by increasing the amount of photosynthetically active radiation and photosynthesis at the lower regions of a crop within an indoor farming environment. A system in accordance with the present disclosure may improve plant biomass and yield with greater efficiency than conventional side lighting systems. A system in accordance with the present disclosure may improve plant biomass and yield at reduced power cost due to lower power usage than conventional side lighting. A system in accordance with the present disclosure may improve plant biomass and yield by positioning an optical axis of a photosynthetically active radiation device parallel to the primary growth axis of the plant. A system in accordance with the present disclosure may improve plant biomass and yield at reduced power cost as a single photosynthetically active radiation device may generate photosynthesis on multiple plants in multiple locations in proximity to the device.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system to provide photosynthetically active photons to a plant, the system comprising:
an above canopy light source, wherein the above canopy light source is an electromagnetic radiation device, the above canopy light source is located above a canopy of the plant, and the above canopy light source emits photosynthetically active photons of a first intensity downward, towards a canopy of the plant; and
an under canopy light source, wherein the under canopy light source is an electromagnetic radiation device, the under canopy light source is located below the lowest branches and leaves of the plant, and the under canopy light source emits photosynthetically active photons of a second intensity upwards, away from a root system of the plant, wherein the second intensity is 0-50 percent of the first intensity.

2. The system of claim 1, wherein the under canopy light source emits a Lambertian emission of photosynthetically active radiation.

3. The system of claim 1, wherein the under canopy light source emits a wide angular emission, wherein emitted photons from the under canopy light source reach a targeted plant within a 180° field-of-view of the under canopy light source.

4. The system of claim 1, wherein the under canopy light source emits wavelengths of light between 400 nm and 700 nm and the above canopy light source emits wavelengths of light between 400 nm and 700 nm.

5. The system of claim 1, wherein the under canopy light source includes one of: a high pressure sodium (HPS) lighting device, a light emitting diode (LED) lighting device, a fluorescent lighting device, and a grow lighting device designed for indoor farming.

6. The system of claim 1, wherein the second intensity is 10-15 percent of the first intensity.

7. The system of claim 1, wherein the above canopy light source includes one of: a high pressure sodium (HPS) lighting device, a light emitting diode (LED) lighting device, a fluorescent lighting device, and a grow lighting device designed for indoor farming.

8. The system of claim 1, wherein the above canopy light source includes a high pressure sodium lighting device and emits electromagnetic radiation for yellow light in the waveband between 570 nm-590 nm.

9. A device to provide photosynthetically active photons to a plant, the device comprising:
an under canopy light source, wherein the under canopy light source is an electromagnetic radiation device, the under canopy light source is located below the lowest branches and leaves of the plant, and the under canopy light source emits photosynthetically active photons of a first intensity upwards away from a root system of the plant, and wherein the first intensity is 0-50 percent of a second intensity;
wherein the second intensity is an intensity of an above canopy light source, wherein the above canopy light source is an electromagnetic radiation device, the above canopy light source is located above a canopy of the plant, and the above canopy light source emits photosynthetically active photons of the second intensity downward, towards the plant canopy.

10. The device of claim 9, wherein the under canopy light source emits a Lambertian emission of photosynthetically active radiation.

11. The device of claim 9, wherein the under canopy light source emits a wide angular emission, wherein emitted photons from the under canopy light source reach a targeted plant within a 180° field-of-view of the under canopy light source.

12. The device of claim 9, wherein the under canopy light source emits wavelengths of light between 400 nm and 700 nm.

13. The device of claim 9, wherein the under canopy light source includes one of: a high pressure sodium (HPS) lighting device, a light emitting diode (LED) lighting device, a fluorescent lighting device, and a grow lighting device designed for indoor farming.

14. The device of claim 9, wherein the first intensity is 10-15 percent of the second intensity.

15. A system to provide photosynthetically active photons to plants planted in an area, the system comprising:
a plurality of above canopy light sources, wherein the above canopy light sources are electromagnetic radiation devices, the above canopy light sources are located above a canopy of the plants, and the above canopy light sources emit photosynthetically active photons of a first intensity downward, towards a canopy of the plants; and
a plurality of under canopy light sources, wherein the under canopy light sources are electromagnetic radiation devices, the under canopy light sources are located below the lowest branches and leaves of the plants, and the under canopy light sources emit photosynthetically active photons of a second intensity upwards away from a root system of the plants, and wherein the second intensity is 0-50 percent of the first intensity.

16. The system of claim 15, wherein the under canopy light sources emit Lambertian emissions of photosynthetically active radiation.

17. The system of claim 15, wherein the under canopy light sources emit wide angular emissions, wherein emitted photons from each under canopy light source reaches targeted plants within a 180° field-of-view of each under canopy light source.

18. The system of claim 15, wherein the under canopy light sources emit wavelengths of light between 400 nm and 700 nm and the above canopy light sources emit wavelengths of light between 400 nm and 700 nm.

19. The system of claim 15, wherein the under canopy light sources include one or more of: a high pressure sodium (HPS) lighting device, a light emitting diode (LED) lighting device, a fluorescent lighting device, and a grow lighting device designed for indoor farming and the above canopy light sources include one or more of: a high pressure sodium (HPS) lighting device, a light emitting diode (LED) lighting device, a fluorescent lighting device, and a grow lighting device designed for indoor farming.

20. The system of claim 15, wherein the second intensity is 10-15 percent of the first intensity.
